(19) United States
(12) Patent Application Publication
(10) Pub. No.: US 2018/0045594 A1
(43) Pub. Date: Feb. 15, 2018

(54) METHOD AND APPARATUS FOR A FORCE APPLICATOR

(71) Applicant: OptoFidelity Oy, Tampere (FI)

(72) Inventors: Petri MANTERE, Tampere (FI); Pertti KAUPPINEN, Tampere (FI)

(21) Appl. No.: 15/236,651

(22) Filed: Aug. 15, 2016

(51) Int. Cl. G01L 25/00; G01L 1/04

(52) U.S. Cl. CPC G01L 25/00; G01L 1/04

(57) ABSTRACT

There is disclosed a method for calibrating a measurement device, in which a probe is coupled with a base part by a flexure. The method includes setting a position of a probe of the measurement device by moving the base part so that a tip of the probe does not touch an object; obtaining information of a location of the probe representing a free weight of the probe; and moving the base part so that the tip of the probe moves towards a surface of the object and obtaining information of the location of the probe until the information indicates that the location of the tip of the probe has changed. There is also disclosed a measurement device including a base part; a probe having a tip; a flexure coupling the base part with the probe; means for moving the base part; and means for obtaining information of a location of the probe without contacting the flexure and/or the probe.

### TECHNICAL FIELD

The aspects of the disclosed embodiments relate to a method for testing and calibrating a force applicator. The invention also relates to an apparatus for testing and calibrating a force applicator.

### BACKGROUND

Apparatuses and methods have been developed for measuring force applied to a testing probe when testing a device by pressing the testing probe on a surface of the device. The device is, for example, a touch panel. One example of such force applicator is a so called dead weight force applicator, which comprises a dead weight attached to a linear guide on a Z-axis (fixed weight). Force application is done by moving Z-axis down far enough to allow the testing probe to be supported by the surface of the device to be tested. This kind of solution may be suitable for point-to-point application (tap gesture) and also for swipe applications (force is applied without a closed loop control). However, practical repeatability in this test for a single, low-friction linear guide may be in the range of +/−10 g. Furthermore, there may be no possibility to control the force without complex mechanical solutions and non-linearities of the linear guide may have significant effects on the applied force.

There may also be other disadvantages with such force applicators, such as long-term performance e.g. in a factory environment may not be good enough due to e.g. dust which may impact the linear guide. Also minimum force caused by dead weight may be limited by the mechanics weight to a relatively high value. In an example device the minimum weight which is about 80 g.

Therefore, there is a need to find an improved method and apparatus for testing and calibrating a measurement device such as a force applicator.

### SUMMARY

One aim of the disclosed embodiments is to provide an improved method and apparatus for testing and calibrating a measurement device such as a force applicator.

According to a first aspect there is provided a method for calibrating a measurement device, in which a probe is coupled with a base part by a flexure, the method comprising:
setting a position of a probe of the measurement device by moving the base part so that a tip of the probe does not touch an object;
obtaining information of a location of the probe representing a free weight of the probe; and
moving the base part so that the tip of the probe moves towards a surface of the object and obtaining information of the location of the probe until the information indicates that the location of the tip of the probe has changed.

According to a second aspect there is provided a method for testing a device by a measurement device, in which a probe is coupled with a base part by a flexure, the method comprising:
setting a position of a probe of the measurement device by moving the base part so that a tip of the probe touches a surface of an object;
receiving information of a force to be induced on the surface of the object by the tip of the probe;
   moving the base part so that the tip of the probe induces a force on the surface of the object, and obtaining information of the location of the probe without contacting the flexure and/or the probe.

According to a third aspect there is provided a measurement device comprising:
a base part;
a probe having a tip;
a flexure coupling the base part with the probe;
means for moving the base part; and
means for obtaining information of a location of the probe without contacting the flexure and/or the probe.

Some advantageous embodiments are defined in the dependent claims.

Some advantages may be achieved by the disclosed embodiments. For example, good linearity and rather small residual for flexure bend/force results may be achieved. In accordance with an embodiment, +/−1 g repeatability can be achieved with a relatively simple control algorithm.

### BRIEF DESCRIPTION OF THE DRAWINGS

In the following the present invention will be described in more detail with reference to the appended drawings, in which

FIG. 1a depicts an example of a flexure as a top view, in accordance with an embodiment;

FIG. 1b depicts an example of behaviour of the flexure of FIG. 1a when a force has been applied to it, in accordance with an embodiment;

FIG. 2a illustrates an example of a probe attached with the flexure of FIGS. 1a and 1 b, in accordance with an embodiment;

FIG. 2b illustrates as a side view of the example of FIG. 2a;

FIG. 3 illustrates as a block diagram of an apparatus for testing and calibrating a force applicator, in accordance with an embodiment;

FIGS. 4a and 4b depict calibration of the apparatus, in accordance with an embodiment; and

FIGS. 5a and 5b depict using the apparatus to test a device, in accordance with an embodiment.

### DETAILED DESCRIPTION

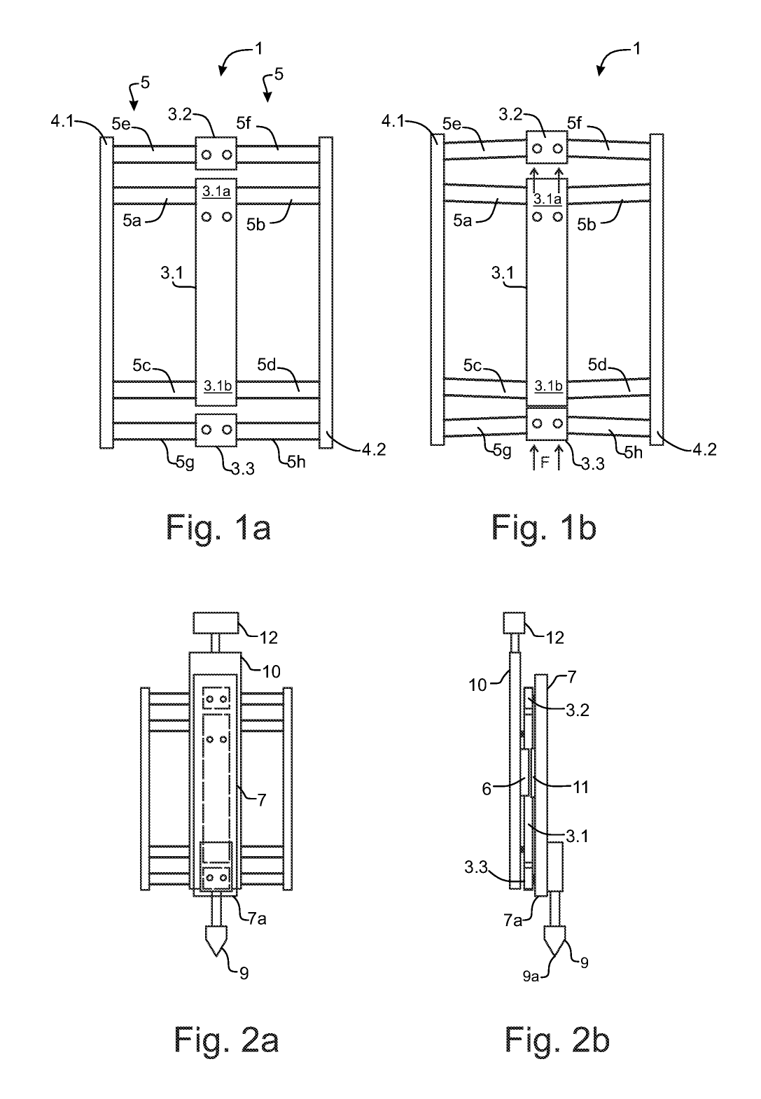

In the following some example embodiments will be described. FIG. 1a illustrates an example of a flexure 1 as a top view, in accordance with an embodiment. In this embodiment the flexure 1, a.k.a. a flexure bearing, comprises a first mounting 3.1, a second mounting 3.2, a third mounting 3.3, a first support beam 4.1 and a second support beam 4.2, and a plurality of pairs of flexible beams 5. Two pairs 5a, 5b of flexible beams near a first end 3.1a of the first mounting 3.1 combine the first mounting 3.1 with the first support beam 4.1 and with the second support beam 4.2, respectively. There are also two other pairs 5c, 5d of flexible beams near a second end 3.1b of the first mounting 3.1 also combining the first mounting 3.1 with the first support beam 4.1 and with the second support beam 4.2. The second mounting 3.2 beside the first end 3.1a of the first mounting 3.1 is combined with the first support beam 4.1 by a pair 5e of flexible beams and with the second support beam 4.2 by another pair 5f of flexible beams. Similarly, the third mounting 3.3 beside the second end 3.1b of the first mounting 3.1 is combined with the first support beam 4.1 by a pair 5g of flexible beams and with the second support beam 4.2 by another pair 5h of flexible beams. The flexible beams 5 allow a mutual, substantially linear movement of the first mounting 3.1 with respect to the second mounting 3.2 and the third mounting 3.3.

FIG. 1b depicts an example of behaviour of the flexure 1 of FIG. 1a when a force F has been applied to it, in accordance with an embodiment. It is also assumed that the second mounting 3.2 and the third mounting 3.3 are coupled to a support 7 so that the distance between the second mounting 3.2 and the third mounting 3.3 remains the same when either the second mounting 3.2 or the third mounting 3.3 is moved. In this example, the force F is applied to the third mounting 3.3 towards the first mounting 3.1. This force F moves the third mounting 3.3 towards the first mounting 3.1 and the second mounting 3.2 further off the first mounting 3.1 (i.e. away from the first mounting 3.1). These movements are illustrated with arrows M1, M2 in FIG. 1b. Furthermore, because the third mounting 3.3 is combined with the first support beam 4.1 and the second support beam 4.2 by the flexible beams 5, the flexible beams 5 move the first support beam 4.1 and the second support beam 4.2 in the direction of the force F, i.e. upwards in the setup of FIG. 1b. The movement of the first support beam 4.1 and the second support beam 4.2 also causes that the flexible beams 5 bend slightly. The flexible beams 5 affect a force-resisting counter force when the flexible beams 5 are bent. The counter force may be linear or non-linear or there may be a linear region when the force F affecting to the flexible beams 5 is within certain limits. The counter force may depend on, among other things, stiffness, thickness, width, length and/or material of the flexible beams 5.

The amount of movement of the second mounting 3.2 and the third mounting 3.3 with respect to the first mounting 3.1 may be measured by an encoder 6. The encoder 6 may be an optical encoder, a magnetic encoder, a sonic encoder or another suitable encoder. The encoder 6 is implemented so that it is not in direct contact with the support 7 but operates in a non-contact manner. Therefore, the encoder 6 does not induce any friction to the movement of the support 7 and the probe 9 attached with the support 7. Thus, the force measurement is not substantially affected by the encoder 6.

In accordance with an embodiment, the encoder 6 is installed on the same base part 10 which is coupled with the first mounting 3.1. If the encoder 6 is an optical encoder, it may have a light transmitter and a light receiver, wherein the support 7 may have a reflector 11, a mirror arrangement or another kind of arrangement which causes reflection of the light illuminated from the light transmitter so that a property of the reflected light received by the light receiver changes as a consequence of the movement of the support 7. For example, the property may be interference wherein the light receiver is capable of sensing changes in the interference.

FIG. 2a illustrates an example of a probe 9 attached with the flexure 1 of FIGS. 1a and 1 b, in accordance with an embodiment, and FIG. 2b illustrates the example of FIG. 2a as a side view. The probe 9 is fixed with the support 7 near a first 7a end of the support. The first mounting 3.1 is fixed to a base part 10. The encoder 6 is also fixed with the base part 10. The reflector 11 is attached with the support 7. An applicator 12 is connected with the base part 10 so that the base part 10 may be moved upwards and downwards (in the direction of Z-axis). The applicator 12 may be, for example, an electric motor or other element capable of moving the base part 10.

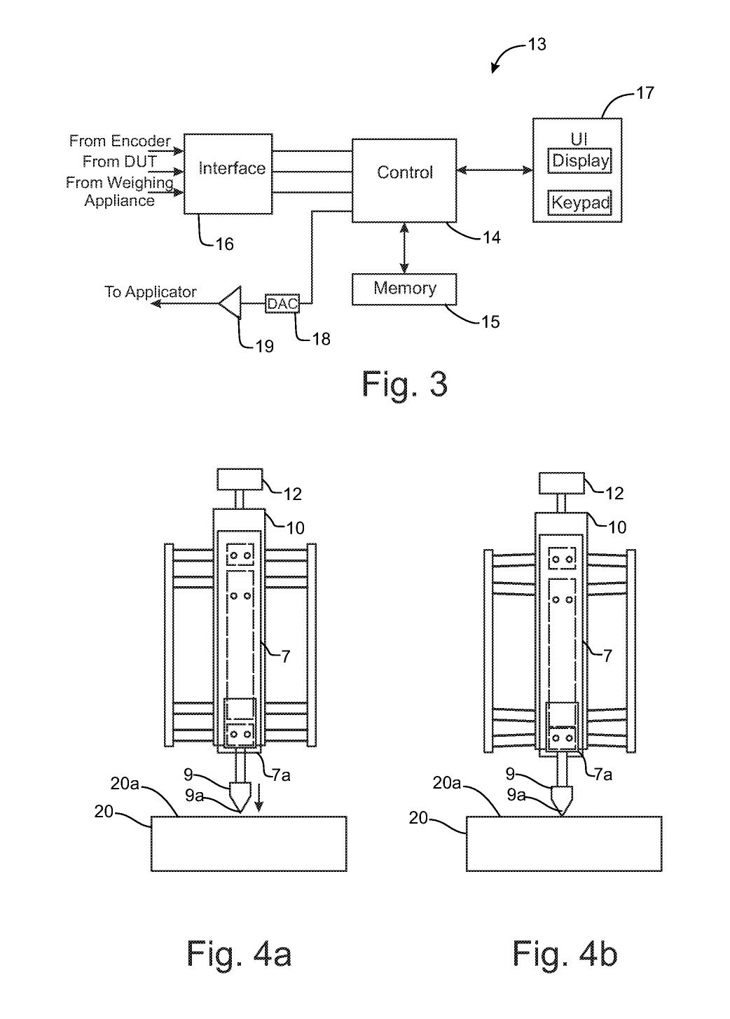

FIG. 3 is a simplified block diagram of an apparatus 13 according to an example embodiment of the present invention. The setup comprises a controller 14 which is adapted to control the operation of the force applicator 12 and at least some of the elements of the force applicator 12. The apparatus 13 also comprises a memory 15 for storing computer code to be executed by the controller 14 and/or for storing data during operation of the apparatus 13. An interface 16 is provided for receiving data from the encoder 6 and for outputting e.g. measurement results. There may also be a user interface 17 for receiving user commands and for providing information to a user of the apparatus. The apparatus 13 may comprise a digital-to-analog converter 18 to convert applicator movement instructions to analog signals and an amplifier 19 for amplifying the analog signals before providing them to the applicator 12.

In the following the operation of the calibration and testing setup is described in more detail with reference to FIGS. 4a and 4b. It is assumed, without limiting the scope of the present invention, that the memory comprises computer code for controlling the operation of the applicator 12 and for reading and processing information received from the encoder 6. The user may instruct the apparatus 13 to begin a calibration procedure. The calibration may be performed e.g. as follows. The controller 14 instructs the applicator 12 to rise the probe 9 so that the tip 9a of the probe 9 does not touch any objects (FIG. 4a). That situation may be detected so that a sensor 9b of the probe 9 indicates that the tip is resting in a first position. The sensor 9b may be a switch, a conductor or other suitable element. At this stage the controller 14 reads the location indication from the encoder 6 and may store this value into the memory 15. This value represents the free weight of the probe, i.e. zero force. Then, the controller 14 may instruct the applicator 12 to move the probe 9 downwards until the tip 9a of the probe 9 touches a surface 20a of an object 20 beneath the probe 9 (FIG. 4b). During the calibration process the object 20 may be a weighing appliance accurate enough for the purposes of calibration. The accuracy needed may depend on applications. In an embodiment the accuracy of the weighing appliance may be better than +/−1 g. In another embodiment a courser accuracy may suffice. The controller 14 may instruct the applicator 12 to move the probe 9 further downwards to induce different forces to the probe 9. The controller 14 may receive several indications from the encoder 6 and weight information from the weighing appliance. Hence, the controller 14 is capable of converting readings from the encoder 6 to corresponding force values. The controller 14 may repeat the above described calibration operations to obtain several pairs of encoder readings and weighing appliance readings and store them, for example, into an encoder reading-to-force conversion table which the controller 14 may use when testing devices.

The pairs of encoder readings and weighing appliance readings may also be called as location—force conversion values because the encoder reading may indicate location of the tip 9a of the probe and the weighing appliance reading may represent the force applied by the probe to the weighing appliance.

During device testing interpolation or extrapolation may be used if the table does not have a conversion value to a specific reading.

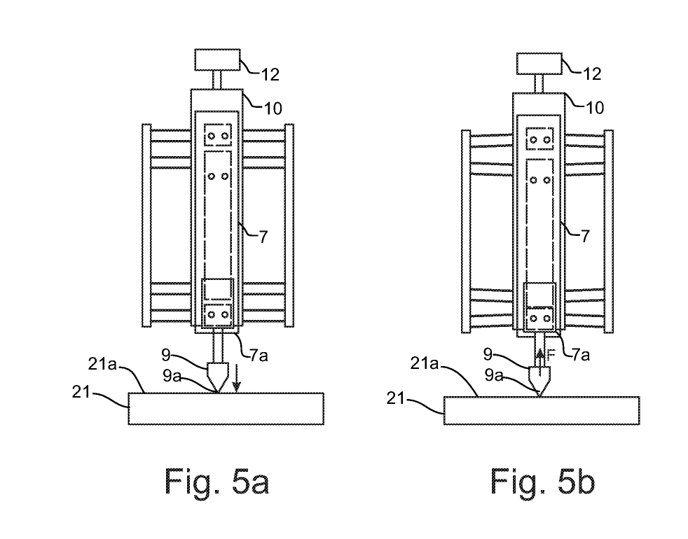

In the following the operation of the apparatus for testing a device 21 is described in more detail with reference to FIGS. 5a and 5b. It is assumed that the apparatus has been calibrated so that the controller 14 is capable of converting encoder readings to force applied to the probe 9 and that the controller 14 is able to receive pressure information from a device under test 21 (DUT) for example wirelessly or in a wired manner. The device 21 is put beneath the probe 9. Then, the controller 14 instructs the applicator 12 to move the probe 9 downwards so that the tip 9a of the probe touches the surface of the device 21 (FIG. 5a). The controller 14 may instruct the applicator 12 to move the probe 9 further downwards to induce different forces to the probe 9 (FIG. 5b). The controller 14 may then receive indications from the encoder 6 and pressure information from the device 21. The controller 14 converts readings from the encoder 6 to corresponding force values, wherein the controller 14 is able to convert pressure information from the device 21 to actual force information. This kind of operation may be used to check the accuracy of the pressure information from the device 21 and/or for calibrating the device 21 so that the pressure information generated by the device 21 corresponds with actual force affected on the surface of the device 21.

Although the above described example relates to force measurement, the apparatus may also be used to measure changes in locations i.e. without converting the readings of the encoder 6 to force. The operation principle may still be similar to the force measurement embodiments. Hence, the probe 9 may follow a surface of a device 21 to be tested. Changes in the location (height) of the probe 9 affect a change to the response the flexure generates regarding the measurement signal. This response is detected by the encoder 6, wherein a change in the response may be converted to a change in a position of the probe 9.

As was mentioned above, the measurement signal may be, for example, an optical signal which may be received by the light receiver. In accordance with another embodiment, the measurement signal may be based on inductance, magnetism or audible signals.

Some non-limiting examples of the device 21 to be mentioned here are a display, a part of a display, a stylus, a part of a stylus e.g. a tip of the stylus, a force sensing element such as a touch panel, etc. In accordance with an embodiment, the force sensing element to be tested is attached with a display.

Embodiments of the flexure 1 may also behave quite linearly during movement in the direction of the surface (x/y-direction) so that so called swipe gestures may be performed on the surface with quite an accurate force. The probe 9 may also be quite stable without substantial z-direction vibrations during x and y axis movement. If some vibrations or other interference would occur, the effect of them can be decreased by using e.g. a filtering algorithm.

In the following some examples will be provided.

According to a first example there is provided a method for calibrating a measurement device, in which a probe is coupled with a base part 10 by a flexure, the method comprising:
setting a position of a probe 9 of the measurement device by moving the base part 10 so that a tip 9a of the probe 9 does not touch an object 20;
obtaining information of a location of the probe 9 representing a free weight of the probe 9; and
moving the base part 10 so that the tip 9a of the probe 9 moves towards a surface 20a of the object 20 and obtaining information of the location of the probe 9 until the information indicates that the location of the tip 9a of the probe 9 has changed.

According to a second example there is provided a method for testing a device by a measurement device, in which a probe 9 is coupled with a base part 10 by a flexure 1, the method comprising:
setting a position of a probe 9 of the measurement device by moving the base part 10 so that a tip 9a of the probe 9 touches a surface of an object 20;
receiving information of a force to be induced on the surface 20a of the object 20 by the tip 9a of the probe 9;
moving the base part 10 so that the tip 9a of the probe 9 induces a force on the surface 20a of the object 20, and obtaining information of the location of the probe 9 without contacting the flexure 1 and/or the probe 9.

According to a third example there is provided a measurement device comprising:
a base part 10;
a probe 9 having a tip 9a;
a flexure 1 coupling the base part 10 with the probe 9;
means 12 for moving the base part 10; and
means for obtaining information of a location of the probe 9 without contacting the flexure 1 and/or the probe 9.

According to a fourth example there is provided a method for calibrating a force applicator, in which a probe 9 is coupled with a base part 10 by a flexure 1, the method comprising:
setting a position of a probe 9 of the force applicator by moving the base part 10 so that a tip 9a of the probe 9 does not touch an object 20;
obtaining information of a location of the probe 9 representing a free weight of the probe 9; and
moving the base part 10 so that the tip 9a of the probe 9 moves towards a surface 20a of the object 20 obtaining information of the location of the probe 9 until the information indicates that the location of the tip 9a of the probe 9 has changed;
obtaining information of a weight indicative of a force caused by the tip 9a of the probe 9 to the surface 20a; and
inserting information of the location and the weight to a conversion table to represent a location—force conversion value.

According to a fifth example there is provided a method for testing a device by a force applicator, in which a probe 9 is coupled with a base part 10 by a flexure 1, the method comprising:
setting a position of a probe 9 of the force applicator by moving the base part 10 so that a tip 9a of the probe 9 touches a surface of an object 20;
receiving information of a force to be induced on the surface 20a of the object 20 by the tip 9a of the probe 9;
moving the base part 10 so that the tip 9a of the probe 9 induces a force on the surface 20a of the object 20, obtaining information of the location of the probe 9 without contacting the flexure 1 and/or the probe 9, and converting the location information to a force value by using a conversion table until the force value corresponds with the force to be induced.

According to a sixth example there is provided a force applicator comprising:
a base part 10;
a probe 9 having a tip 9a;
a flexure 1 coupling the base part 10 with the probe 9;
means 12 for moving the base part 10;
means for obtaining information of a location of the probe 9 without contacting the flexure 1 and/or the probe 9, said location representing a force applied to the tip 9a of the probe 9; and
a conversion table for performing conversion between location and force values.

The present invention is not limited to the above described embodiments but can be modified within the scope of the appended claims.

We claim:

1. A method for calibrating a measurement device, in which a probe is coupled with a base part by a flexure, the method comprising:
setting a position of a probe of the measurement device by moving the base part so that a tip of the probe does not touch an object;
obtaining information of a location of the probe representing a free weight of the probe; and
moving the base part so that the tip of the probe moves towards a surface of the object and obtaining information of the location of the probe until the information indicates that the location of the tip of the probe has changed.

2. The method according to claim 1, further comprising:
obtaining information of a weight indicative of a force caused by the tip of the probe to the surface; and
inserting information of the location and the weight to a conversion table to represent a location—force conversion value.

3. The method according to claim 2, further comprising repeating steps of moving the base part, obtaining information of the location of the tip of the probe, obtaining information of the weight, and inserting information of the location and the weight to a conversion table to form several location—force conversion values.

4. The method according to claim 1, further comprising obtaining information of a location of the tip of the probe by receiving location information from an encoder of the force applicator.

5. The method according to claim 2, further comprising obtaining information of a location of the tip of the probe by receiving location information from an encoder of the force applicator.

6. The method according to claim 3, further comprising obtaining information of a location of the tip of the probe by receiving location information from an encoder of the force applicator.

7. The method according to claim 4, further comprising obtaining location information without contacting the flexure and/or the probe.

8. A method for testing a device by a measurement device, in which a probe is coupled with a base part by a flexure, the method comprising:
setting a position of a probe of the measurement device by moving the base part so that a tip of the probe touches a surface of an object;
receiving information of a force to be induced on the surface of the object by the tip of the probe;
moving the base part so that the tip of the probe induces a force on the surface of the object, and obtaining information of the location of the probe without contacting the flexure and/or the probe.

9. The method according to claim 8, further comprising converting the location information to a force value by using a conversion table until the force value corresponds with the force to be induced.

10. The method according to claim 9, further comprising interpolating values of the conversion table if the conversion table does not contain a location value corresponding to the force to be induced.

11. A measurement device comprising:
a base part;
a probe having a tip;
a flexure coupling the base part with the probe;
means for moving the base part; and
means for obtaining information of a location of the probe without contacting the flexure and/or the probe.

12. The measurement device according to claim 11, wherein in that the means for obtaining information of a location of the probe comprises:
means for generating a measurement signal to be applied to the flexure;
means for receiving a response to the measurement signal induced by the flexure; and
means for converting the response to said information of the location.

13. The measurement device according to claim 11, comprising a contactless encoder for obtaining information of a location of the probe.

14. The measurement device according to claim 12, comprising a contactless encoder for obtaining information of a location of the probe.

15. The measurement device according to claim 13, wherein the encoder is at least one of the following:
an optical encoder;
a magnetic encoder;
a sonic encoder.

16. A force applicator comprising:
a base part;
a probe having a tip;
a flexure coupling the base part with the probe;
means for moving the base part; and
means for obtaining information of a location of the probe without contacting the flexure and/or the probe.

17. The force applicator according to claim 16, wherein the means for obtaining information of a location of the probe comprises:
means for generating a measurement signal to be applied to the flexure;
means for receiving a response to the measurement signal induced by the flexure; and
means for converting the response to said information of the location.
